(19) United States
(12) Patent Application Publication
(10) Pub. No.: US 2007/0114332 A1
(43) Pub. Date: May 24, 2007

(54) Softer-parachute deployment deceleration assist device

(76) Inventor: Tommy Herbert Giles III, Columbus, GA (US)

Correspondence Address: Tommy H. Giles, III, 2814 Ramsey Road, Columbus, GA, 31903, US

(21) Appl. No.: 11/282,903

(22) Filed: Nov. 18, 2005

(51) Int. Cl. B64D 17/00

(52) U.S. Cl. 244/142

(57) ABSTRACT

The Softer is a flexible, inflatable device attached to the Riser Connector Links or equivalent of a parachute system. It automatically inflates during normal parachute canopy deployment providing extra drag to lessen the opening shock forces. Upon full canopy inflation it can be collapsed or removed for better canopy aerodynamic performance.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to the opening sequence of a deploying parachute, specifically to attenuate the opening shock forces, the snatch force and the canopy opening force.

A parachute system normally consists of a suspended weight (referred to as the jumper), a harness (attaches the parachute to the jumper), a container (holds the packed parachute during freefall), a canopy (flexible material to slow the decent of the jumper) and suspension lines (attaches the canopy to the harness via Risers and Connector Links). The Risers (normally four, two pair (Left and Right, and Front and Rear)) are attached to the harness. At the end of each Riser there is normally a Connector Link (metal, oval ring or equivalent). The suspension lines are attached, in groups, to the Connector Links that are attached to the Risers which is attached to the harness. The canopy is normally contained in a bag to make packing easier and to help attenuate the opening shock during canopy deployment. A pilot chute is normally attached to the bag/canopy and is used to extract the bag/canopy from the container. With ram air parachutes a Slider is normally used. It normally consists of a rectangular piece of material with four grommets in the corners. The four line groups from the canopy are routed through the grommets. The slider is pushed up to the bottom of the canopy during packing. During deployment the Slider “slides” down the lines to the Connector Links. This slows and provides an orderly canopy deployment.

Two main opening shock forces are Snatch Force and Canopy Opening Shock. The Snatch Force is when the suspension lines are fully extended and the canopy is accelerated to the speed of the jumper. This is very sudden, sharp and over very quickly (less than a second). Next, the canopy will began to spread from its packed position to its fully inflated condition. With proper attenuation (i.e. bag, slider and proper design) and packing technique the Canopy Opening Shock will be spread over a short duration (several seconds). The Canopy Opening Shock may be less than the Snatch Force but of longer duration.

### BACKGROUND OF THE INVENTION—PRIOR ART

Older style parachutes (Round canopies) used material with a porosity that allowed air to penetrate it. They also had suspension lines that would stretch when a load was applied. When packed in a deployment device (sleeve or bag, etc.), generally the opening shock was not too great (there were exceptions however). Now almost all parachutes (except some military, emergency and special use) are of the Ram-Air type. The normal parachute material now is of Low or Zero-Porosity with non-stretchable suspension lines. The parachute is aerodynamically like an airfoil (airplane wing) and needs to maintain the airfoil shape. Many times the opening shock is high. The original Slider (non-patented) was developed in the 1970's. Normally it is a rectangular material with four grommets or rings in the corners. The suspension lines feed through 4 grommets or rings. The Slider is pressed against the canopy during packing to restrict the canopy initially and allow it to open in a controlled manner. Sometimes a Pocket would be sewed on the leading edge of the slider to further control the opening. The Slider is used on almost all Ram-Air canopies today. There have been patents issued on variations of the basic slider. Tandem parachutes (passenger attached to a tandem master with an extra large canopy) use a drogue parachute to slow the passenger/tandem master during freefall to the speed of a single jumper in freefall. Some older style “round” parachutes used a center line to pull down the apex of the canopy to increase the size of the canopy. Normally the “round” parachutes used a small opening or vent at the apex to increase stability. A small Pilot Chute is put in the wind stream and pulls the main canopy for deployment.

The opening shock is dependent on the difference in the velocity of the jumper and canopy upon line stretch (snatch force) and canopy deployment. Opening shock may be perceived differently by different jumpers. All would agree that opening the canopy shortly after exiting the aircraft (before reaching terminal velocity) will have less opening shock than when opening the same canopy at terminal velocity (maximum speed of a freefalling jumper). A larger jumpsuit, reduction in jumper weight, lighter canopy, smaller pilot chute or slower opening speed and proper packing procedure will assist to lessen the opening shock.

There is a multitude of prior art pertaining to parachutes, pilot chutes, drogue chutes and Slider variations. The pilot chutes and drogue chutes are used to extract the main chute or stabilize the load prior to the main chute deploying.

The Softer is unique in that it is used during deployment to slow the jumper prior to the opening sequence. It is attached to the connector links, not the bag or container.

### BACKGROUND OF THE INVENTION—OBJECTS AND ADVANTAGES

Accordingly, several objects and advantages of my invention are:
(a) Packs easily and completely in all existing parachute containers with very little increase in weight or volume.
(b) Is totally contained inside the container so it has no affect during freefall.
(c) Is deployed automatically and positively when the container is opened.
(d) Slows the jumper before the Snatch force and Canopy deployment occurs to lessen the opening shock.
(e) Will tend to straighten the jumpers body position (if tilted) to the normal deployment position to reduce the chance of a canopy malfunction.
(f) Is easily collapsed and stowed or removed after full canopy deployment.
(g) A slower opening will result in better canopy deployments (less malfunctions), less chance of injury for the jumper, less fatigue for the jumper or load, less physical wear and tear on the canopy and container system during deployment and better canopy aerodynamics (less line stretch causing airfoil distortion). Further objects and advantages of my invention will become apparent from a consideration of the drawings and ensuing description.

### SUMMARY

The Softer is contained in the container then deploys automatically with the bag/canopy. It slows the jumper during the opening sequence thereby lessening the opening shock on the jumper for better and more enjoyable canopy deployments. The Softer is unique in that it is used during deployment to slow the load during the opening sequence and is attached to the connector links, not the bag or container.

### DRAWINGS—FIGURES

FIG. 1 is perspective view of the Softer showing the various parts

FIG. 2 shows the additional parts of the Quick Release Assembly

### DRAWINGS—REFERENCE NUMERALS

10 Side of Softer material (2 needed)

12 Seam (attaching material (10))

13 Vent

15 Binding Tape for edge reinforcement

17 Attachment Loops to attach the Softer to riser connector links (2 needed)

40 Attachment Lines to attach the Softer or Quick Release Assembly to the riser connector links (2 needed)

51 Dee Ring (2 needed)

52 Retaining Pin (2 needed)

53 Small Rubber Band (2 needed)

54 Quick Release Tab with lanyard (2 needed)

### DETAILED DESCRIPTION—PREFERRED EMBODIMENT—FIGS

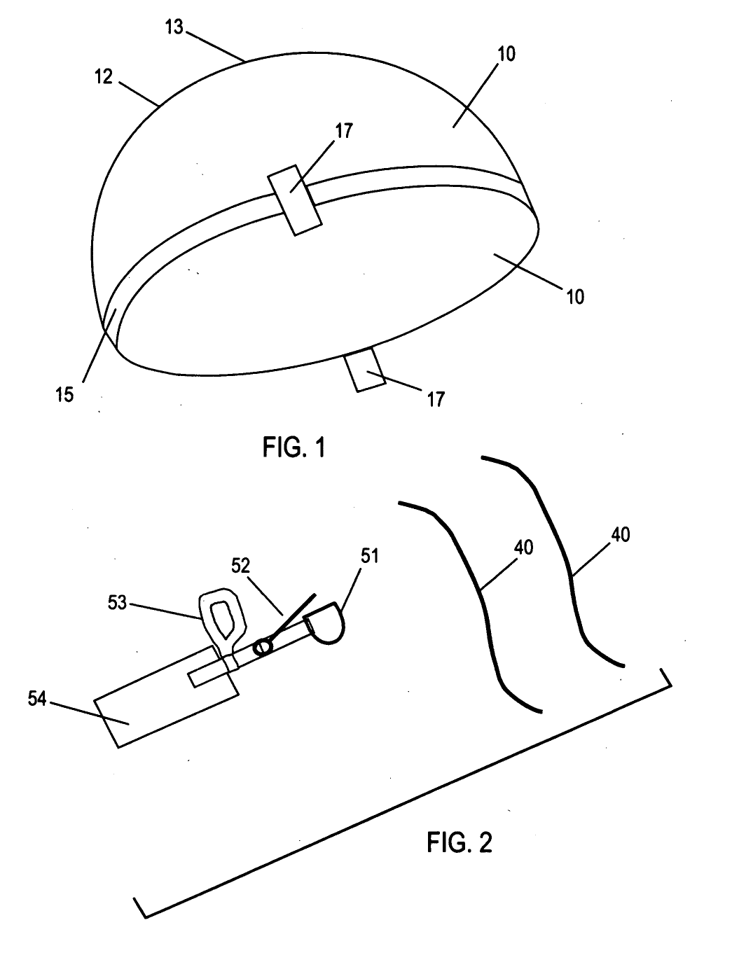

A preferred embodiment of the present invention (Softer) is illustrated in FIG. 1. It consists of two pieces of material (10 and 10) attached together by a seam (12) with an open side at the bottom (similar to a pocket). The base of the open side is shown reinforced with binding tape (15). Attached to the sides of the material are two loops (17 and 17) to provide attachment points to the Connector Links. Attachment Loops (17 and 17) are shown sewn to the bottom edges of the Softer but the placement could vary. Two Attachment Lines (40 and 40) are used to connect the Softer or Quick Release Assembly to the Connector Links or equivalent. The Softer could be connected to the Connector Links directly (40 connected to 17) but this is an easier method and permits removal if desired. Binding Tape (15) can be sewn at the open edge for reinforcement.

FIG. 2 shows a version of a Quick Release Assembly. Two are needed for the Left and Right sides. The Dee Ring (51), Retaining Pin (52) and Rubber Band (53) are attached to the Tab (54) via a lanyard. The Dee Ring (51) is attached to the Connector Link with the Attachment Line (40). The Attachment Loop (17) is threaded through the Dee Ring (51). The Retaining Pin (52) is inserted through the Attachment Loop (17). The Rubber Band (53) is looped behind the Dee Ring (51) and around the Retaining Pin (52) to secure the Attachment Loop (17) in place. After the canopy is inflated, the Tab is pulled disengaging the Attachment Loop (17). The Quick Release Assembly remains attached to the Connector Link. The Softer can then be stowed in the jumper's jumpsuit.

### OPERATION—PREFERRED EMBODIMENT—FIGS

As shown in FIG. 1 the Softer consists of two pieces of material attached with a seam (12) and an open end. The material (10 and 10), as shown, is semi-circular but rectangular and triangular pieces have been used. The Attachment Loops (17 and 17) hold the Softer/Quick Release Assembly to the Connector Links via the Attachment Lines (40 and 40). There could be direct attachment of the Attachment Loops (17 and 17) to the Connector Links but the described method is easier, allows detachment and does not require the Connector Links to be opened.

When inflated, the Softer acts as a small drogue chute to slow the jumper's velocity permitting softer openings. The Softer is attached to one set (Left and Right) of the Connector Links or equivalent. The Front and Rear sets of Connector Links are together during initial deployment.

To permit a quicker and more positive presentation to the wind stream, the apex of the Softer is attached to the canopy deployment bag. One method is to attach a small rubber band on one of the bag line stow loops for apex stowage. This permits an easy attachment to hold the Softer during initial canopy deployment. It pulls the Softer into the wind stream. The apex has a vent (13) to make the Softer more stable and not collapse during deployment.

FIG. 2 shows a version of a Quick Release Assembly. It is used for both the Left and Right sides. The Attachment Loop (17) is threaded through the Dee Ring (51), which is attached to the Connector Link with the Attachment Line (40). The Retaining Pin (52) is inserted through the Attachment Loop (17). The Rubber Band (53) is looped behind the Dee Ring (51) and around the Retaining Pin (52) to secure the Attachment Loop (17) in place. After the canopy is inflated, the Tab of the Lanyard is pulled disengaging the Attachment Loop (17). The Quick Release mechanism remains attached to the Dee Ring on the Connector Link. The Softer can then be stowed in the jumper's jumpsuit and reattached during packing. This device would be very beneficial for accuracy jumpers. Also those needing maximum aerodynamic efficiency or performing high-speed landings and not wishing to be concerned with an open Softer affecting the canopy aerodynamics.

FIG. 1 depicts the Softer in its deployment configuration. Note that it is inflated by the uprushing wind stream and is held to the risers by the Connector Links or equivalent by the Attachment Loops (17 and 17) and Attachment Lines (40 and 40). The purpose of the Softer is to provide additional drag during the deployment stage to reduce the opening shock and provide a softer opening.

### DESCRIPTION—ALTERNATIVE EMBODIMENT—FIGS

Various materials can be used for the Softer but generally Zero-Porosity parachute material is preferred. It is strong, thin (less bulk) and lightweight (less weight) and provides a lot of drag when deployed. While various shapes of the Softer (FIG. 1) were tried, the semi-circular design for the material (10 and 10) provides a number of advantages. It uses less material hence less weight and less bulk than a rectangular design. Since the inflated area is about the same the less bulk is desirable as it is easier to handle. It can be attached to either the Front or Rear Risers. Both work equally well but the Front Risers will not interfere with the toggle line if the riser was twisted during the Softer attachment. This is my preferred attachment point. The Softer is attached to the bag via a small rubber band for a more positive deployment. It has been tested without this attachment and seems to work equally well. A vent (13) in the apex releases some of the pressure and makes the Softer more stable. The Quick Release Assembly (FIG. 2) would be beneficial in most cases. Most probable are accuracy jumpers and those performing high-speed landings. They should remove the Softer to prevent the possibility of any unexpected aerodynamic anomalies from occurring during landing.

Instead of the Quick Release Assembly (FIG. 2) an alternate method of reducing the drag while under canopy was tried. Two Retaining Loops with rubber bands were sewn to the back quarter of the binding tape but the number and placement could vary. The purpose of these is to hold the Softer in a deflated condition after full canopy deployment to reduce drag. The Softer would be rolled into a tube configuration then a bight formed in the center. The bight is held by the rubber bands. This takes more time to setup after canopy deployment and could come undone and cause problems during landing. While it works, the idea is not as good as the Quick Release Assembly.

### CONCLUSION, RAMIFICATIONS, AND SCOPE

Accordingly, the reader will see that, according to the invention, it is simple to attach to the connector links and pack. It has no affect on the freefall portion the jump. It deploys automatically with canopy deployment and can be collapsed or removed upon complete canopy deployment. It provides additional drag during the critical snatch force and canopy deployment phase. This will reduce the opening shock on the jumper for a safer and softer opening.

While the above description contains many specifications, these should not be construed as limitations on the scope of the invention, but as exemplification's of the presently preferred embodiments thereof. Many other ramifications and variations are possible within the teachings of the invention. For example, there should be some means to deflate or remove the Softer after deployment. Shown on this application is the preferred method. Various other means and methods would also work to accomplish the same objectives. A pressure release opening (vent—13) near the apex may be incorporated also.

Thus the scope of the invention should be determined by the appended claims and their legal equivalents, and not by the examples given.

I claim:

1. A parachute deceleration assist device applicable to any parachute system consisting of:

2. A component of the device in claim 1 is a pocket shaped device attached to the parachute harness assembly.

3. A component of the device in claim 1 is made of flexible material attached together with a seam or seams and one open edge.

4. The material can have a pressure release vent.

5. A component of the device in claim 1 is attached to the harness risers by the connector links or equivalent or other means.

6. A component of the device in claim 1 is contained in the parachute container until the bag/canopy is released for deployment.

7. A component of the device in claim 1 can be temporarily secured to the canopy deployment device such as a bag to assist in deployment.

8. A component of the device in claim 1 is designed to inflate when presented to the prevailing wind stream.

9. A component of the device in claim 1 can be deflated and held closed or removed from the attachment points after full canopy inflation.
